(19) United States
(12) Patent Application Publication
(10) Pub. No.: US 2024/0127301 A1
(43) Pub. Date: Apr. 18, 2024

(54) DATABASE SYSTEMS AND METHODS OF CONFIGURABLE INVOICE GENERATION

(71) Applicant: Salesforce, Inc., San Francisco, CA (US)

(72) Inventors: Rekha Koratikere Narayan, Fremont, CA (US); Prabhjot Singh, Union City, CA (US)

(73) Assignee: Salesforce, Inc., San Francisco, CA (US)

(21) Appl. No.: 18/047,502

(22) Filed: Oct. 18, 2022

(51) Int. Cl. G06Q 30/04; G06F 16/28

(52) U.S. Cl. CPC G06Q 30/04; G06F 16/285

(57) ABSTRACT

Database systems and methods are provided for automatically generating records at a database system in a configurable and customizable manner. One method involves using a key value associated with a configuration to identify related records at a database system associated with the key value and identify configuration metadata associated with the configuration at the database system. The method continues by providing a graphical user interface (GUI) display at a client device coupled to the database system over a network, where the GUI display includes a first region including a first subset of the records grouped into a first group based on the configuration metadata and a first common field value and a second region including a second subset of the records grouped into a second group based on the configuration metadata and a second common field value.

### TECHNICAL FIELD

One or more implementations relate to the field of database systems, and more specifically, to a database system that supports configurable, automated generation of invoice records.

### BACKGROUND

Modern software development has evolved towards web applications or cloud-based applications that provide access to data and services via the Internet or other networks. For example, social media platforms and other collaborative web sites allow users to exchange direct messages or form groups for broadcasting messages and collaborating with one another. In business environments and customer relationship management (CRM) contexts, communication platforms facilitate users sharing information about sales opportunities or other issues surrounding products or services and track changes to projects and sales opportunities by receiving broadcast updates about coworkers, files, and other project related data objects.

In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. Multi-tenant cloud-based architectures have been developed to support multiple user groups (also referred to as “organizations” or “tenants”) using a common hardware and software platform. Some multi-tenant database systems include an application platform that supports a customizable user experience, for example, to create custom applications, web pages, reports, tables, functions, and/or other objects or features.

In a CRM setting or other business context, subscription-based products or services are often utilized to build customers and provide predictable growth and income streams. However, during the course of a subscription, a customer or account may purchase any number of different additional products or services, or make various changes (e.g., changes to quantity, price, subscription duration, subscription type, etc.) to the subscription as a result of upselling, downselling, renewals, suspensions or resumptions, cancellations, and the like. In practice, a particular customer may desire to be invoiced in a particular manner, based on their particular preferences, factoring in jurisdictional legal or regulatory requirements or other generally accepted accounting practices for a particular jurisdiction or geographic region. However, existing cloud-based services can be inflexible and limit the ability of a particular product or service provider to accommodate a customer's preferences by requiring invoices to be generated in a fixed manner defined by the particular CRM platform (e.g., to ensure auditability and accurate accounting). This may result in a customer receiving an undesirable number of separately generated invoices (e.g., due to inability to group related invoices), or result in invoices that present information in a nonintuitive or undesirable manner, for example, by failing to group or split related invoice line items in the desired manner, improperly rounding values at a particular invoice line level, and/or the like. Accordingly, it is desirable to provide a flexible service capable of accommodating various customizations and configurations of invoicing while maintaining accounting, auditability, legal and/or regulatory compliance, and the like.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a computing system that supports customizable automated invoice generation according to some exemplary implementations;

FIG. 2 is a table depicting an exemplary custom invoice configuration suitable for use in the computing system of FIG. 1 according to some exemplary implementations;

FIG. 3 is a block diagram of a billing system suitable for use in the computing system of FIG. 1 according to some exemplary implementations;

FIG. 4 is a table of order records and corresponding invoice configuration key values in accordance with the custom invoice configuration of FIG. 2 suitable for use with the billing service of FIG. 3 in the computing system of FIG. 1 according to some exemplary implementations;

FIG. 5 is an exemplary hierarchical invoice graphical user interface (GUI) display suitable for presentation on a client device in the computing system of FIG. 1 according to some exemplary implementations;

FIG. 6 is a flow diagram illustrating an invoice generation process suitable for implementation in connection with the billing service of FIG. 3 in the computing system of FIG. 1 according to some example implementations;

FIG. 7A is a block diagram illustrating an electronic device according to some example implementations; and

FIG. 7B is a block diagram of a deployment environment according to some example implementations.

### DETAILED DESCRIPTION

The following description describes implementations for automatic generation of invoices in a flexible, customizable and user-configurable manner, rather than limiting invoices to a static platform-defined invoice configuration that may not suit the needs of a particular customer, user or organization. In this regard, the subject matter described herein enables custom grouping, rounding, and presentation of invoice line items in a hierarchical manner, thereby allowing invoices to be generated in a flexible and configurable manner to satisfy the needs or desires of a particular customer, organization, user or other entity and maintain compliance with applicable legal, regulatory or accounting requirements. For example, some jurisdictions may permit or allow rounding of line item values to the minimum denomination of currency, while others require line item values be calculated to a particular number of decimals after that minimum denomination (e.g., two decimals). Additionally, line items can be grouped by different common fields or attributes, for example, by common business unit, geographic region, billing type and/or the like.

As described in greater detail below, exemplary implementations described herein generate or otherwise determine a key value that is associated with a particular invoice configuration and assign or otherwise associate that key value with corresponding billing records maintained at a database system for which that invoice configuration is to be applied. Thereafter, a service associated with the database system utilizes the key value associated with that invoice configuration to identify the set of billing records associated with the key value to be grouped or otherwise combined on a common invoice. The service similarly utilizes the key value to identify the invoice configuration metadata associated with that invoice configuration to generate a corresponding invoice record that groups or otherwise combines the identified set of billing records (e.g., by copying or referencing field values of those billing records to corresponding fields of the invoice record) in a manner that reflects the desired invoice split levels and rounding configured for that particular invoice configuration. Thereafter, when a user views or accesses that autogenerated invoice record at the database system, the database system generates or otherwise provides an invoice graphical user interface (GUI) display that includes different regions, which are populated with invoice lines corresponding to different, distinct subsets of the set of billing records that are grouped in accordance with the invoice configuration metadata based on having a common field value for a particular field. In this regard, the invoice record and corresponding invoice GUI display are hierarchically formatted and split into groups by the desired invoice split levels defined by the invoice configuration metadata.

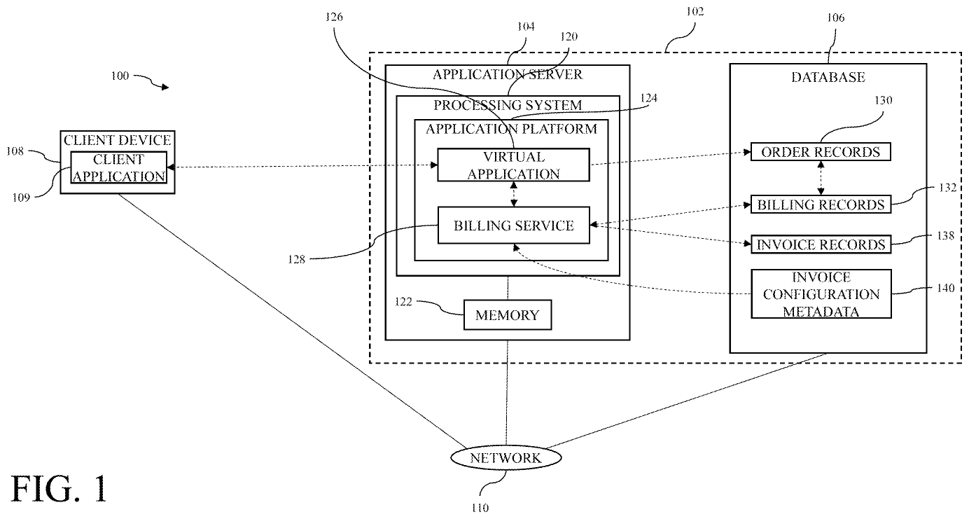

FIG. 1 depicts an exemplary computing system 100 capable of supporting customizable automated invoice generation using invoice configuration metadata 140 and billing records 132 maintained at a database system 102. It should be appreciated that FIG. 1 is a simplified representation of a computing system 100 and is not intended to be limiting. In the illustrated implementation, the database system 102 includes one or more servers 104 that users of client devices 108 may interact with, over a communications network 110 (e.g., the Internet or any sort or combination of wired and/or wireless computer network, a cellular network, a mobile broadband network, a radio network, or the like), to view, access or obtain data or other information from one or more data records at a database 106 or other repository associated with the database system 102.

In one or more exemplary implementations, the database system 102 includes one or more application servers 104 that support an application platform 124 capable of providing instances of virtual applications 126, over the network 110, to any number of client devices 108 that users may interact with to obtain data or other information from one or more data records 114 maintained in one or more data tables 112 at the database 106 associated with the database system 102. For example, the database 106 may maintain, on behalf of a user, tenant, organization or other resource owner, data records entered or created by that resource owner (or users associated therewith), files, objects or other records uploaded by the resource owner (or users associated therewith), and/or files, objects or other records automatically generated by one or more computing processes (e.g., by the server 104 based on user input or other records or files stored in the database 106). In this regard, in one or more implementations, the database system 102 is realized as an on-demand multi-tenant database system that is capable of dynamically creating and supporting virtual applications 126 based upon data from a common resource database 106 that is shared between multiple tenants, which may alternatively be referred to herein as a multi-tenant database. Data and services generated by the virtual applications 126 may be provided via the network 110 to any number of client devices, as desired, where instances of the virtual application may be suitably generated at run-time (or on-demand) using a common application platform 124 that securely provides access to the data in the database 106 for each of the various tenants subscribing to the multi-tenant system.

The application server 104 generally represents the one or more server computing devices, server computing systems or other combination of processing logic, circuitry, hardware, and/or other components configured to support remote access to data records maintained in the data tables at the database 106 via the network 110. Although not illustrated in FIG. 1, in practice, the database system 102 may include any number of application servers 104 in concert with a load balancer that manages the distribution of network traffic across different servers 104 of the database system 102.

In exemplary implementations, the application server 104 generally includes at least one processing system 120, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. Additionally, although not illustrated in FIG. 1, in practice, the application server 104 may also include one or more communications interfaces, which include any number of transmitters, receiver, transceivers, wired network interface controllers (e.g., an Ethernet adapter), wireless adapters or another suitable network interface that supports communications to/from the network 110 coupled thereto. The application server 104 also includes or otherwise accesses a data storage element 122 (or memory), and depending on the implementation, the memory 122 may be realized as a random-access memory (RAM), read only memory (ROM), flash memory, magnetic or optical mass storage, or any other suitable non-transitory short- or long-term data storage or other computer-readable media, and/or any suitable combination thereof. In exemplary implementations, the memory 122 stores code or other computer-executable programming instructions that, when executed by the processing system 120, are configurable to cause the processing system 120 to support or otherwise facilitate the application platform 124 and the subject matter described herein.

The client device 108 generally represents an electronic device coupled to the network 110 that may be utilized by a user to access an instance of the virtual application 126 using an application 109 executing on or at the client device 108. In practice, the client device 108 can be realized as any sort of personal computer, mobile telephone, tablet or other network-enabled electronic device coupled to the network 110 that executes or otherwise supports a web browser or other client application 109 that allows a user to access one or more GUI displays provided by the virtual application 126. In exemplary implementations, the client device 108 includes a display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device 108. The illustrated client device 108 executes or otherwise supports a client application 109 that communicates with the application platform 124 provided by the processing system 120 at the application server 104 to access an instance of the virtual application 126 using a networking protocol. In some implementations, the client application 109 is realized as a web browser or similar local client application executed by the client device 108 that contacts the application platform 124 at the application server 104 using a networking protocol, such as the hypertext transport protocol (HTTP). In this manner, in one or more implementations, the client application 109 may be utilized to access or otherwise initiate an instance of a virtual application 126 hosted by the database system 102, where the virtual application 126 provides one or more web page GUI displays within the client application 109 that include GUI elements for interfacing and/or interacting with records 114 maintained at the database 106.

In exemplary embodiments, the database 106 stores or otherwise maintains data for integration with or invocation by a virtual application 126 in objects organized in object tables. In this regard, the database 106 may include any number of different object tables configured to store or otherwise maintain alphanumeric values or other descriptive information that define a particular instance of a respective type of object associated with a respective object table. For example, the virtual application may support a number of different types of objects that may be incorporated into or otherwise depicted or manipulated by the virtual application, with each different type of object having a corresponding object table that includes columns or fields corresponding to the different parameters or criteria that define a particular instance of that object. In some implementations, the database 106 stores or otherwise maintains application objects (e.g., an application object type) where the application object table includes columns or fields corresponding to the different parameters or criteria that define a particular virtual application 126 capable of being generated or otherwise provided by the application platform 124 on a client device 108. In this regard, the database 106 may also store or maintain graphical user interface (GUI) objects that may be associated with or referenced by a particular application object and include columns or fields that define the layout, sequencing, and other characteristics of GUI displays to be presented by the application platform 124 on a client device 108 in conjunction with that application 126.

In exemplary implementations, the database 106 stores or otherwise maintains additional database objects for association and/or integration with a virtual application 126, which may include custom objects and/or standard objects. For example, an administrator user associated with a particular resource owner may utilize an instance of a virtual application 126 to create or otherwise define a new custom field to be added to or associated with a standard object, or define a new custom object type that includes one or more new custom fields associated therewith. In this regard, the database 106 may also store or otherwise maintain metadata that defines or describes the fields, process flows, workflows, formulas, business logic, structure and other database components or constructs that may be associated with a particular application database object. In various implementations, the database 106 may also store or otherwise maintain validation rules providing validation criteria for one or more fields (or columns) of a particular database object type, such as, minimum and/or maximum values for a particular field, a range of allowable values for the particular field, a set of allowable values for a particular field, or the like, along with workflow rules or logical criteria associated with respective types of database object types that define actions, triggers, or other logical criteria or operations that may be performed or otherwise applied to entries in the various database object tables (e.g., in response to creation, changes, or updates to a record in an object table).

For example, as described in greater detail below, in exemplary implementations, the database 106 stores or otherwise maintains an order database object table that includes entries corresponding to different order database records 130 associated with a particular resource owner. In this regard, an entry for an order record 130 maintains user-configurable values or criteria associated with that particular order, such as, for example, a quantity or number of units associated with the particular order, a name or other identifier associated with the product or asset that is the subject of the order, the unit price associated with the order, the total price associated with the order, the start date and/or end date for the particular order, and identifiers or references to any original or parent order to be associated with the respective order. For example, in some implementations, the order database records 130 may include a parent order record that maintains an association with a particular account or customer to be billed along with other higher level order configuration data (e.g., order start date, contract end date, order amount total, order end data, order name or other identifiers, order type, etc.) along with one or more child order product records associated with the parent order record that maintain the order details for a particular product or service (e.g., a quantity or number of units, a name or other identifier associated with the product or asset, the unit price, the total price, the start date and/or end date, etc.) that are associated with the different distinct order-related events associated with the parent order record. For example, a first child order product database record may maintain order details associated with an original or initial order or subscription for a particular product or service to be associated with a particular parent order record, while additional child order product database records may maintain order details associated with additions, reductions or other changes or amendments to the original or initial order related to that same parent order record.

In exemplary implementations, an instance of a virtual application 126 may provide, within the client application 109, one more GUI displays including one or more GUI elements manipulable by a user of the client device 108 to input the order details or other order criteria and create or otherwise define one or more new order records 130 to be supported for a customer of a particular resource owner. After defining the criteria to be associated with the respective order, the virtual application 126 creates one or more corresponding entries in the database 106 to maintain the corresponding order record(s) 130 for that particular order, subscription or amendment thereto.

In exemplary implementations, the application platform 124 includes or otherwise supports a billing service 128 that is configurable to utilize the user-configured order criteria from the different related order records 130 associated with a particular resource owner to generate corresponding billing records 132 (e.g., billing schedule records, billing period transaction records, and/or the like) that support automations, reports or other functionality at the database system 102 while providing accurate accounting and auditability. For example, for each order record 130, the billing service 128 may automatically generate a billing schedule record 132 associated with the particular order record 130 using values from one or more fields of data associated with the order record 130 to support automatically generating corresponding billing period transaction records 132 that may be utilized for invoicing the respective order in accordance with the order configuration data defined for that order record 130. In this regard, the billing schedule and billing period transaction records 132 generated by the billing service 128 allow for the different related orders to be billed asynchronously and/or independently from one another.

In exemplary implementations described herein, the billing service 128 utilizes the billing records 132 to automatically generate corresponding invoice records 138 in the database 106, which, in turn, may be utilized to invoice the customer of the particular resource owner in a configurable and customizable manner in accordance with invoice configuration metadata 140 maintained in the database 106. In this regard, an instance of a virtual application 126 may provide, within the client application 109, one more GUI displays including one or more GUI elements manipulable by a user of the client device 108 that allow an administrator or other user associated with a particular resource owner to define various values or criteria for the invoice configuration metadata 140 to be applied to their order records 130. For example, in concert with placement or generation of an order, the user may utilize one or more GUI elements within the virtual application 126 to select or define the particular set of invoice configuration criteria to be applied to that particular order. The invoice configuration criteria may include, for example, indicia of what fields or field values should be utilized to identify and group related billing records 132 using a common invoice record 138, what fields or field values should be utilized to split invoice line items corresponding to those grouped billing records 132 into different hierarchical levels or regions on the invoice GUI display, whether or not to round off invoice lines at a particular hierarchical level, and the like.

In one or more exemplary implementations, the billing service 128 stores or otherwise maintains one or more tables of invoice configuration metadata 140 at the database system 102, where each entry (or row) in the invoice configuration metadata table includes a configuration identification field (or column) including a unique identifier assigned to the particular invoice configuration, a grouping criterion field including indication of a particular field or attribute that defines a particular hierarchical level of the invoice by which to group subsets of billing records 132, a hierarchical level assignment field including indication of the hierarchical level to be assigned to that grouping criterion field, a split configuration field including indication of whether or not the invoice should be split or grouped based on the grouping criterion field, and a rounding configuration field including indication of whether and/or how invoice line items should be rounded off at that particular hierarchical level. In this regard, the virtual application 126 may include GUI elements that allow a user to define values for the grouping criterion field that dictate how the different line items corresponding to the different billing records 132 are arranged into different hierarchical levels and grouped or split into separate invoice records 138, whether or how values of the different line items corresponding to the different billing records 132 are rounded at the invoice record 138.

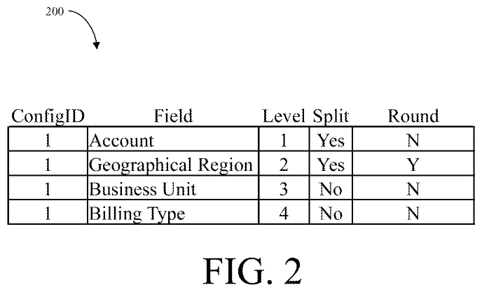

FIG. 2 depicts an exemplary invoice configuration metadata table 200 for an exemplary invoice configuration that is capable of being stored or otherwise maintained as invoice configuration metadata 140 in the database 106 of the database system 102. As shown, the invoice configuration metadata table 200 includes a configuration identification field including the unique identifier assigned to the invoice configuration (e.g., ConfigID=1), a grouping criterion field including indicia of the different data fields associated with the billing records (e.g., Account, Geographical Region, Business Unit, Billing Type), a hierarchical level assignment field including indicia of the different hierarchical levels to be assigned to the different billing record data fields (e.g., Account=1, Geographical Region=2, etc.), a split configuration field indicating which of the different data fields associated with the billing records should be used to determine when to split the invoice into separate invoice records 138 rather than grouping records into a common invoice (e.g., Business Unit=No), and a rounding configuration field including indication of whether or not that invoice line items at that particular hierarchical level should be rounded (e.g., Geographical Region=Yes). Accordingly, order records 130 assigned the configuration identifier will have their corresponding billing records 132 grouped by a common combination of account and geographical region field values, with line items for different billing units and billing types grouped into separate regions on the invoice GUI display for the invoice record 138 corresponding to the grouped set of billing records 132 having common account and geographical region field values and the cumulative total values at the geographical region hierarchical level being rounded.

Referring again to FIG. 1, in exemplary implementations, when a particular invoice configuration is assigned to an order record 130, the billing service 128 automatically generates a key value to be assigned to an invoice configuration field of the billing records 132 to be associated with that order record 130 using the invoice configuration metadata 140 associated with that designated invoice configuration. In one or more exemplary implementations, the billing service 128 generates the key value by concatenating or otherwise combining the value for the configuration identification field associated with the assigned invoice configuration with the values for the different data fields of the billing records 132 associated with that order record 130 that correspond to the different grouping criterion fields where the invoice configuration indicates the invoices are to be split. For example, referring to FIG. 2, in response to generating a billing schedule record 132 associated with an order record 130 assigned the invoice configuration depicted in table 200, the billing service 128 assigns an invoice configuration key value to that billing schedule record 132 by concatenating or otherwise combining the configuration identification field associated with the assigned invoice configuration (e.g., ConfigID=1), the value for the account field associated with the billing schedule record 132 (which may be autopopulated or derived from the account field of the order record 130), and the value for the geographical region field associated with the billing schedule record 132 (which may be similarly autopopulated or derived from the account field of the order record 130). The resulting invoice configuration key value (e.g., “1-AccountName-GeographicalRegion”) may be assigned or otherwise associated with the billing schedule record 132, for example, by autopopulating an invoice configuration field of the billing schedule record 132 with the generated invoice configuration key value. In this regard, other billing schedule records 132 created for different order records 130 having the same combination of invoice configuration, account and geographical region field values may be assigned the same invoice configuration key value, and thereby, be grouped into a common invoice record 138, as described in greater detail below.

Still referring to FIG. 1, in one or more implementations, the billing service 128 utilizes billing configuration metadata associated with an order record 130 to automatically generate a corresponding billing schedule record 132 that supports billing the particular customer or account at the particular time or frequency defined by the order in a particular manner defined by the order. Thereafter, the billing service 128 utilizes the billing configuration metadata associated with the billing schedule records 132 to automatically generate corresponding billing period transaction records 132 associated with the billing schedule records 132 corresponding to different billable events for which the particular customer or account is to be billed in accordance with that particular billing schedule, and thereby facilitate billing the customer or account in the contracted manner pursuant to the order record 130. For example, if the order record 130 corresponds to a subscription-based product or service to be billed on a monthly basis on a particular day of the month, the billing service 128 automatically generates a corresponding billing schedule record 132 having data fields populated with that billing configuration metadata associated with the order record 130 to define a corresponding billing schedule for billing that customer or account on a monthly basis on that particular day of the month. On that particular day of the month, the billing service 128 utilizes the billing configuration metadata associated with the billing schedule record 132 to automatically generate a corresponding billing period transaction record 132 associated with (or having a child relationship to) that billing schedule record 132 to automatically create or otherwise instantiate a billable event associated with that order record 130 at the database system 102. In this manner, the billing schedule records 132 are utilized by the billing service 128 to automatically generate corresponding billing period transaction records 132 associated with different billable events for which the particular customer or account is to be billed in accordance with that particular billing schedule.

In one or more implementations, the billing service 128 automatically populates or otherwise assigns the invoice configuration key value to the billing period transaction records 132 (e.g., by autopopulating an invoice configuration field of the billing period transaction record 132 with the invoice configuration key value associated with the parent billing schedule record 132), thereby allowing the billing service 128 to identify which billing period transaction records 132 should be grouped into a common invoice record 138 at the billing period transaction level. That said, in other implementations, the billing service 128 may utilize the invoice configuration key value assigned to the parent billing schedule records 132 to identify which billing schedules should be grouped into a common invoice record 138 at the billing period transaction level before retrieving the data values for populating the line items of the invoice record 138 from the child billing period transaction records 132 associated with the grouped billing schedule records 132.

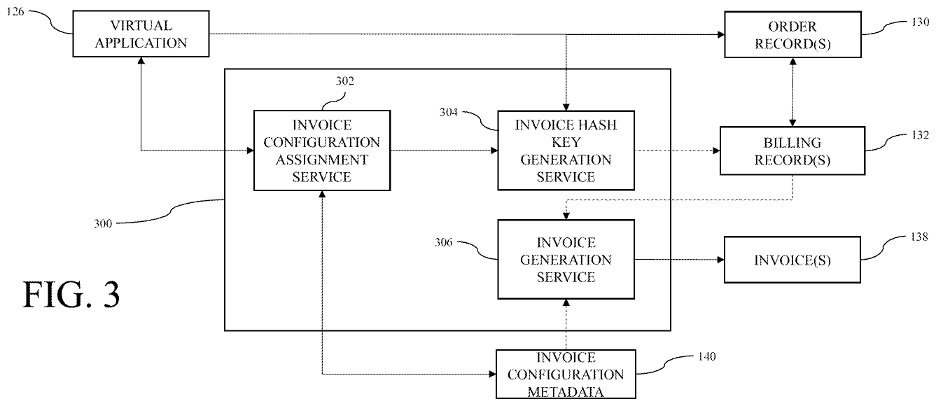

FIG. 3 depicts an exemplary implementation of a billing system 300 suitable for use as the billing service 128 in the computing system 100 in FIG. 1. The billing system 300 includes, without limitation, an invoice configuration assignment service 302, an invoice hash key generation service 304 and an invoice generation service 306 that are cooperatively configurable to automatically generate invoice records 138 at the database system 102 that group different billing records 132 in accordance with designated invoice configuration metadata 140 maintained at the database system 102.

The invoice configuration service 302 receives or otherwise obtains, from or via the virtual application 126, indicia of a desired invoice configuration selected or defined by a user of the client device 108 to be assigned or otherwise associated with a particular order record 130. In this regard, as described above, in concert with placement of an order or otherwise instantiating or configuring an order record 130, a user may utilize one or more GUI elements within a GUI display provided by the virtual application 126 select or otherwise identify an existing invoice configuration to be assigned to that order record 130 (e.g., via a picklist or drop-down menu GUI element) or define a new invoice configuration to be assigned to the order record 130. When the user selects an existing invoice configuration, the invoice configuration assignment service 302 may retrieve or otherwise obtain, from the database 106, the invoice configuration criteria associated with the selected invoice configuration maintained in a table of invoice configuration metadata 140 at the database 106. In this regard, the invoice configuration assignment service 302 retrieves or otherwise obtains the configuration identifier assigned to the selected invoice configuration along with indicia of the different order record data fields to be utilized for grouping or splitting invoices in accordance with that selected invoice configuration. For example, continuing the example of FIG. 2, when the depicted invoice configuration is selected, the invoice configuration assignment service 302 retrieves the configuration identifier of 1 along with information identifying the account and geographical region data fields that are utilized for grouping or splitting invoices in accordance with the selected invoice configuration. On the other hand, when the user defines a new invoice configuration, the invoice configuration assignment service 302 may automatically assign a unique configuration identifier to the new invoice configuration and write, put or otherwise store the defined invoice configuration criteria in a table of invoice configuration metadata 140 at the database 106, while locally maintaining the new configuration identifier and the indicia of the order record data fields for invoice grouping or splitting. In some implementations, the invoice configuration service 302 may include or otherwise support an application programming interface (API) that allows a user of the client device 108 to input or otherwise provide a desired invoice configuration identifier to be utilized to override an invoice configuration stored or otherwise maintained in association with a set of related billing records 132 and dynamically generate an invoice record for that billing schedule or set of related billing records 132 using a different invoice configuration than the invoice configuration previously utilized to generate the invoice configuration key value associated with those billing records 132.

The invoice hash key generation service 304 communicates or otherwise interacts with the invoice configuration assignment service 302 to retrieve or otherwise obtain indicia of the invoice configuration identifier and the corresponding order record data fields for invoice grouping or splitting to be utilized when dynamically generating an invoice configuration key value to be associated with any billing schedule records 132 to be generated by the billing service 128 in response to creating of an order record 130. As described above, in one or more implementations, the billing service 128 automatically generates a billing schedule record 132 to be associated with an order record 130 using billing configuration metadata associated with the order record 130. In this regard, when an order record 130 is created or instantiated, the relevant data fields of the order record 130 may be posted or otherwise added to a queue for processing by the billing service 128 to generate corresponding billing schedule records 132. The invoice hash key generation service 304 retrieves or otherwise obtains the relevant subset of order record data from the queue and utilizes the invoice configuration assignment information received from the invoice configuration assignment service 302 for that order record 130 to automatically generate an invoice configuration key value to be associated with the autogenerated billing schedule record 132 by concatenating or otherwise combining the invoice configuration identifier and the values for the selected subset of order record data to be utilized for grouping or splitting invoices. In this regard, in exemplary implementations, the invoice configuration key value reflects the unique invoice configuration identifier, the order record data fields at which invoices are to be grouped or split in accordance with that invoice configuration, and the order record data fields at which rounding is to be applied in accordance with that invoice configuration. The invoice hash key generation service 304 stores or otherwise maintains the determined invoice configuration key value in association with the billing schedule record 132, for example, by setting the value of an invoice configuration field of the billing schedule record 132 to the determined invoice configuration key value. In this regard, the invoice configuration field of the billing schedule records 132 (or their child billing period transaction records 132) may be utilized to index and identify related billing schedules and/or billable events to be grouped together on common invoices. It will be appreciated that indexing records using the hash key value for the invoice configuration field allows for the billing records to be queried efficiently and provides scalability (e.g., rather than relying on an identifier to locate the configuration metadata and then scanning individual records to determine hash key values for grouping at run time).

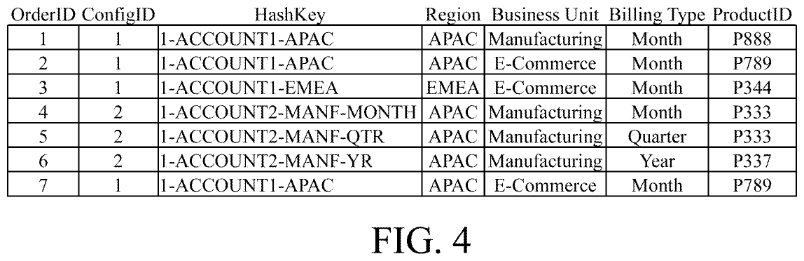

FIG. 4 depicts an exemplary set of order records and corresponding invoice configuration key values that may be assigned to those records by the invoice hash key generation service 304. In this regard, the first (OrderID=1), second (OrderID=2) and seventh (OrderID=7) in the table depicted in FIG. 4 are assigned the invoice configuration depicted in FIG. 2 (ConfigID=1) and have common account and geographical region field values, resulting in a common invoice configuration key value (HashKey=1−ACCOUNT1-APAC) to be associated with the billing records for those order records. The third order depicted in the table of FIG. 4 is assigned the same invoice configuration but has a different geographic region field value, and as a result, is assigned a different invoice configuration key value (HashKey=1−ACCOUNT1-EMEA) that results in the third order being split into a different invoice with the same invoice configuration. The fourth, fifth and sixth orders depicted in the table of FIG. 4 are associated with a different invoice configuration that is configured to split invoices with different billing types, and accordingly, each of the fourth, fifth and sixth orders is assigned a different invoice configuration key value.

Referring again to FIG. 3, the invoice generation service 306 utilizes the invoice configuration metadata 140 associated with a particular invoice configuration identifier to automatically generate an invoice record 138 that supports presenting a hierarchical invoice GUI display with line items corresponding to different billing transaction period records 132 associated with billing schedule records 132 that are associated with or otherwise indexed to a particular invoice configuration key value. Depending on the implementation, the invoice generation service 306 may be configured to generate or update invoice records 138 automatically on a periodic basis (e.g., daily, weekly, monthly, or the like), asynchronously in response to occurrence of a particular event (e.g., a billable event corresponding to a new billing period transaction record 132) or manually in response to user input received via the virtual application 126. In this regard, in some implementations, the invoice configuration metadata 140 associated with a particular invoice configuration may also include values for one or more criteria or parameters that govern or otherwise dictate when the invoice generation service 306 generates or updates an invoice record 138. To generate an invoice record 138, the invoice generation service 306 uses the invoice configuration key value to search, query or otherwise index the billing records 132 to identify the subset of billing records 132 to be grouped into a particular invoice, and then utilizes the hierarchical level assignment field and rounding configuration field to format values obtained from one or more data fields of the billing records 132 into the desired hierarchical level with the desired rounding of values for that hierarchical level. In exemplary implementations, the invoice generation service 306 stores or otherwise maintains the autogenerated invoice record 138 with the formatted values from the grouped billing records 132 in a corresponding table in the database 106 for subsequent reference or retrieval by the application platform 124 and/or the virtual application 126 to generate a corresponding invoice GUI display at client device 108.

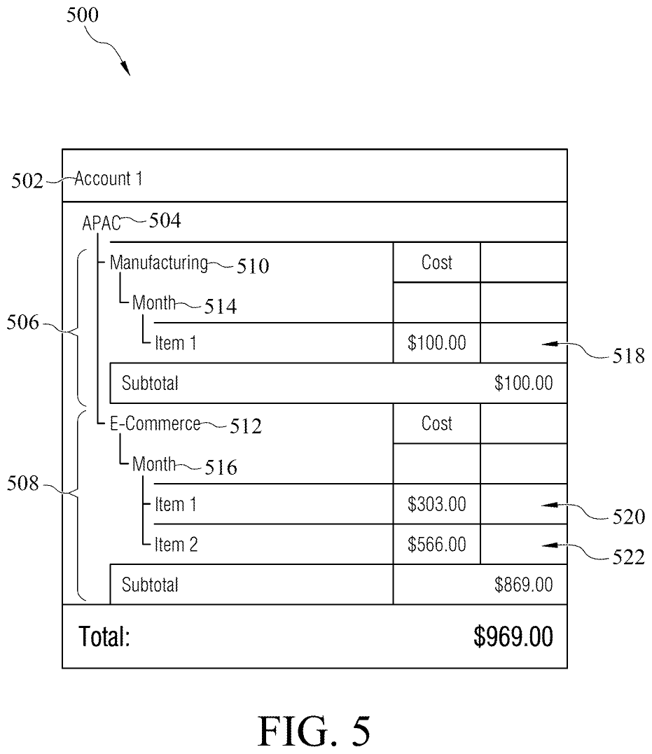

FIG. 5 depicts an exemplary hierarchical invoice GUI display 500 that may be generated by the application platform 124 and/or the virtual application 126 for an invoice record 138 generated by the invoice generation service 306 based on a subset of billing records corresponding to the order records depicted in the table of FIG. 4 that are associated with or otherwise assigned the invoice configuration depicted in FIG. 2, in particular, the subset of billing records associated with the first, second and seventh order records in the table depicted in FIG. 4 that were assigned a common invoice configuration key value (HashKey=1−ACCOUNT1-APAC). Based on the formatting of the invoice record 138 in accordance with the invoice configuration metadata depicted in FIG. 2, the application platform 124 and/or the virtual application 126 generates the invoice GUI display 500 in a hierarchical manner by providing a top level graphical indication or representation 502 of the value for the account field of the grouped subset of billing records 132 that was assigned the highest level (or level 1) defined by the invoice configuration metadata, followed by a graphical indication or representation 504 of the value for the geographical region field of the grouped subset of billing records 132 that was assigned the next level below the highest level (e.g., level 2) in the invoice configuration metadata. In this regard, the graphical indication 504 of the second level of the hierarchical invoice GUI display 500 may be presented beneath the graphical indication 502 of the top level, indented or offset from the graphical indication 502 of the top level, or otherwise depicted in a manner that conveys the hierarchical relationship between the depicted value for the geographical region field and the depicted value for the account field.

The hierarchical invoice GUI display 500 further includes graphical indicia or representations of the different values for the business unit field of the grouped subset of billing records 132 that was assigned the next level in the hierarchy (e.g., level 3) defined by the invoice configuration metadata at which the invoice configuration groups (or does not split) records associated with the same invoice configuration. In this regard, the hierarchical invoice GUI display 500 includes a first region 506 depicted underneath or subsidiary to the graphical indication 504 of the next highest level that includes the invoice line items associated with billing records 132 having a first value for the business unit field (e.g., “Manufacturing”) that includes a graphical indication or representation 510 of the respective value for that business unit field. Similar to the second level graphical indication 504, the graphical indication 510 may be presented beneath the second level graphical indication 504, indented or offset from the second level graphical indication 504, or otherwise depicted in a manner that conveys the hierarchical relationship between the depicted value for the business unit field and the depicted value for the geographical region field. Similarly, the hierarchical invoice GUI display 500 includes a second region 508 that is distinct from the first region 506 but similarly depicted underneath or subsidiary to the graphical indication 504 of the next highest level and which includes a graphical indication or representation 512 of the respective value for that business unit field that is different from that associated with the business unit field of the first region 510 (e.g., “E-Commerce”).

In a similar manner, within each business unit subregion 506, 508 of the hierarchical invoice GUI display 500, graphical indicia or representations of the different values for the billing type field of the grouped subset of billing records 132 that was assigned the next level down in the invoice hierarchy (e.g., level 4) at which the invoice configuration groups (or does not split) records. Thus, one or more regions may be depicted underneath (or within) a higher level region 506, 508, which may similarly be depicted underneath (or within) another higher level region, and so on, until reaching the top level of the invoice hierarchy. In the illustrated example, a graphical indication or representation 514 of the respective value for the billing type field is depicted beneath and indented or offset from the business unit graphical indication 510 to convey the hierarchical relationship between the depicted value for the billing type field (and the invoice line items contained therein) and the depicted value for the business unit field. Similarly, within the other billing unit region 508, a graphical indication or representation 516 of the respective value for the billing type field is depicted beneath and indented or offset from the business unit graphical indication 512 to convey the hierarchical relationship. By virtue of the hierarchical arrangement of the invoice GUI display 500, a user may recognize that the graphical representation 518 of an invoice line item underneath the hierarchical level indicator 514 is associated with a billing record 132 associated with an order record 130 having a monthly billing configuration, and which is also associated with the manufacturing business unit in the Asia-Pacific region for the depicted account (e.g., OrderID=1 in FIG. 4) by virtue of the overlying hierarchical level indicia 502, 504, 510. Similarly, the graphical representations 520, 522 of invoice line items underneath hierarchical level indicator 516 may be recognized as being associated with billing records 132 is associated with order records 130 having a monthly billing configuration that are associated with the e-commerce business unit in the Asia-Pacific region for the depicted account.

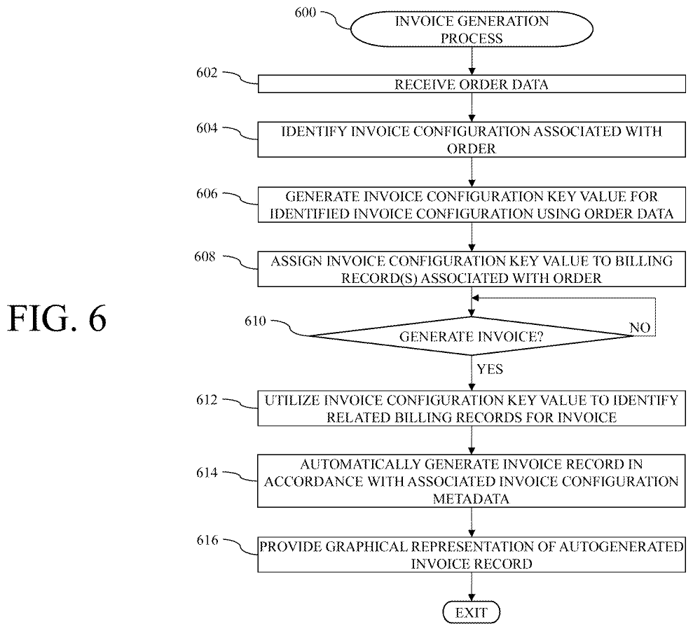

FIG. 6 depicts an exemplary invoice generation process 600 suitable for implementation by a service supported by an application platform at a database system, such as the billing service 128 at the database system 102, to automatically group related records maintained at the database system into a common, configurable autogenerated invoice and perform additional tasks, functions, and/or operations described herein. For illustrative purposes, the following description may refer to elements mentioned above in connection with FIGS. 1-5. It should be appreciated that the invoice generation process 600 may include any number of additional or alternative tasks, the tasks need not be performed in the illustrated order and/or the tasks may be performed concurrently, and/or the invoice generation process 600 may be incorporated into a more comprehensive procedure or process having additional functionality not described in detail herein. Moreover, one or more of the tasks shown and described in the context of FIG. 6 could be omitted from a practical implementation of the invoice generation process 600 as long as the intended overall functionality remains intact.

In exemplary implementations, the invoice generation process 600 initializes or otherwise begins in response to receiving order data associated with an order record and identifying or otherwise determining an invoice configuration associated with the order record (tasks 602, 604). For example, as described above in the context of FIG. 1, when a user interacts with an instance of a virtual application 126 presented within a client application 109 at a client device 108 to create or update an order record 130 in the database 106, the billing service 128 receives or otherwise obtains the order configuration data provided by the user along with indicia of the invoice configuration that the user would like to apply to the order record 130. In this regard, the order configuration data may include information or data that quantifies the particular product or service associated with the order (e.g., the number of units, price per unit, and/or the like) and information or data that qualifies or characterizes the customer or account associated with the order (e.g., geographical region, business unit, and/or the like) along with the billing configuration data that indicates when and how the customer or account associated with that particular order is to be billed for that particular product or service (e.g., monthly, quarterly, yearly, and/or the like). As described above, in exemplary implementations, in concert with creating or updating an order record 130, the virtual application 126 generates or otherwise provides one or more GUI elements that allow the user to interface with the billing service 128 to identify an existing invoice configuration or define a new invoice configuration to be associated with the order record 130 (e.g., via the invoice configuration assignment service 302).

After receiving order data and a desired invoice configuration for an order, the invoice generation process 600 continues by automatically generating or otherwise determining an invoice configuration key value for the identified invoice configuration using the order data and automatically assigning the invoice configuration key value to the billing records associated with the order (tasks 606, 608). For example, based on the order record data fields identified by the grouping criteria and invoice splitting criteria associated with the invoice configuration, the billing service 128, 300 and/or the invoice hash key generation service 304 parses or otherwise analyzes the order configuration data to extract or otherwise identify the respective current values for those data fields of the order record 130 by which invoices are to be grouped or split for the identified invoice configuration. The billing service 128, 300 and/or the invoice hash key generation service 304 concatenates or otherwise combines the extracted current values for those order record data fields with the unique identifier associated with the selected invoice configuration to arrive at the invoice configuration key value for the order record 130. The billing service 128, 300 and/or the invoice hash key generation service 304 automatically assigns or otherwise associates the invoice configuration key value with the billing records 132 associated with the order record 130, for example, by autopopulating or otherwise updating an invoice configuration field of the billing records 132 to the determined invoice configuration key value. For example, in exemplary implementations, the billing service 128, 300 and/or the invoice hash key generation service 304 automatically assigns the invoice configuration key value to a billing schedule record 132 which maintains an association between the invoice configuration key value and child billing period transaction records 132 that represent or otherwise correspond to billable events related to a particular billing schedule for a particular order record 130 to be incorporated into subsequently generated invoice records 138 related to that order record 130.

In the illustrated implementation, after assigning the invoice configuration key value to the billing records associated with a particular order, the invoice generation process 600 detects or otherwise identifies when to generate, create or update an invoice associated with the order (task 610). For example, in one or more implementations, the billing service 128, 300 and/or the invoice generation service 306 may automatically detect or otherwise determine when to generate an invoice based at least in part on the invoice configuration metadata 140 and/or the billing configuration data associated with the billing records 132 and/or the order records 130. For example, the billing configuration data and/or the invoice configuration metadata 140 may define how a customer or account is to be billed in connection with a particular order record 130, for example, periodically or on a periodic basis (e.g., on a monthly basis, a quarterly basis, a semi-annual basis, an annual basis and/or the like) or asynchronously in response to a user request or occurrence of another event (e.g., in response to a billable event).

When the invoice generation process 600 determines that an invoice associated with a particular invoice configuration key value should be generated or updated, the invoice generation process 600 utilizes the invoice configuration key value to search or otherwise query the billing records in the database to identify the related billing records for grouping into a common invoice and then automatically creates or updates an invoice record that includes data field values from the related billing records that are formatted or otherwise arranged in accordance with the invoice configuration data (tasks 612, 614). For example, as described above, the billing service 128, 300 and/or the invoice generation service 306 may utilize the invoice configuration key value as a search key or index to identify a subset of billing records 132 in the database 106 that share the same invoice configuration key value which are to be grouped on a common invoice, and then creates or otherwise updates an invoice record 138 associated with that invoice configuration key value that includes or otherwise incorporates values from one or more data fields of the subset of billing records 132 to provide line items on the resulting invoice GUI display. In this regard, the data field values from the different billing period transaction records 132 to be included on a common invoice record 138 may be formatted or otherwise arranged in the invoice record 138 to provide the desired hierarchical relationship between the different line items for the different billing period transaction records 132, in a similar manner as described above in the context of FIGS. 4-5.

In the illustrated implementation, the invoice generation process 600 generates or otherwise provides a graphical representation of the autogenerated invoice record that includes line items corresponding to different billing records associated with an order record that are hierarchically formatted in accordance with the invoice configuration selected for that order record (task 616). For example, as described above in the context of FIGS. 4-5, when a user of a client device 108 interacts with an instance of the virtual application 126 to view, access or otherwise analyze an invoice record 138, the virtual application 126 and/or the billing service 128 utilizes the formatting of the invoice record 138 to generate a hierarchical invoice GUI display 500 with graphical representations of different billing period transaction records 132 associated with the same invoice configuration key value formatted as different line items grouped together in a hierarchical manner in accordance with the invoice configuration metadata 140 defined for that particular invoice configuration, with values rounded at the appropriate levels of the invoice hierarchy as defined by the invoice configuration.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

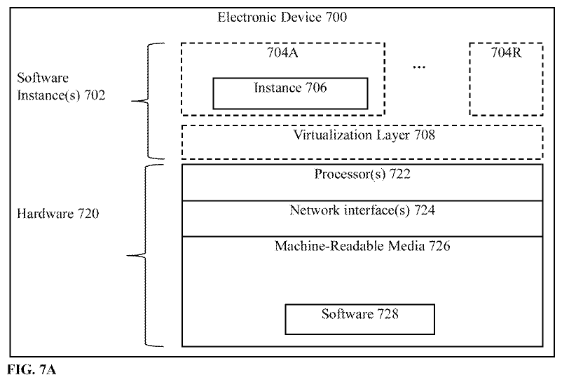

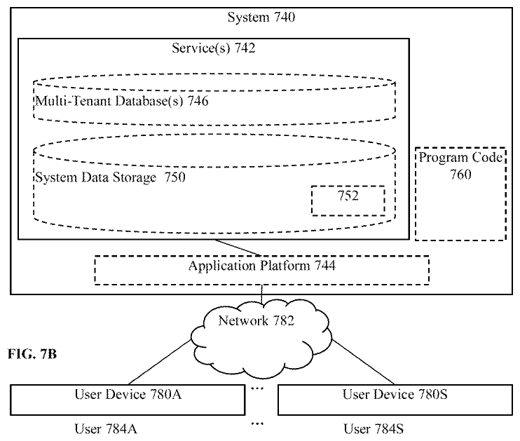

FIG. 7A is a block diagram illustrating an electronic device 700 according to some example implementations. FIG. 7A includes hardware 720 comprising a set of one or more processor(s) 722, a set of one or more network interfaces 724 (wireless and/or wired), and machine-readable media 726 having stored therein software 728 (which includes instructions executable by the set of one or more processor(s) 722). The machine-readable media 726 may include non-transitory and/or transitory machine-readable media. Each of the previously described clients and a billing service may be implemented in one or more electronic devices 700. In one implementation: 1) each of the clients is implemented in a separate one of the electronic devices 700 (e.g., in end user devices where the software 728 represents the software to implement clients to interface directly and/or indirectly with the billing service (e.g., software 728 represents a web browser, a native client, a portal, a command-line interface, and/or an application programming interface (API) based upon protocols such as Simple Object Access Protocol (SOAP), Representational State Transfer (REST), etc.)); 2) the billing service is implemented in a separate set of one or more of the electronic devices 700 (e.g., a set of one or more server devices where the software 728 represents the software to implement the billing service); and 3) in operation, the electronic devices implementing the clients and the billing service would be communicatively coupled (e.g., by a network) and would establish between them (or through one or more other layers and/or or other services) connections for submitting requests to the billing service. Other configurations of electronic devices may be used in other implementations (e.g., an implementation in which the client and the billing service are implemented on a single one of electronic device 700).

During operation, an instance of the software 728 (illustrated as instance 706 and referred to as a software instance; and in the more specific case of an application, as an application instance) is executed. In electronic devices that use compute virtualization, the set of one or more processor(s) 722 typically execute software to instantiate a virtualization layer 708 and one or more software container(s) 704A-704R (e.g., with operating system-level virtualization, the virtualization layer 708 may represent a container engine (such as Docker Engine by Docker, Inc. or rkt in Container Linux by Red Hat, Inc.) running on top of (or integrated into) an operating system, and it allows for the creation of multiple software containers 704A-704R (representing separate user space instances and also called virtualization engines, virtual private servers, or jails) that may each be used to execute a set of one or more applications; with full virtualization, the virtualization layer 708 represents a hypervisor (sometimes referred to as a virtual machine monitor (VMM)) or a hypervisor executing on top of a host operating system, and the software containers 704A-704R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 728 is executed within the software container 704A on the virtualization layer 708. In electronic devices where compute virtualization is not used, the instance 706 on top of a host operating system is executed on the “bare metal” electronic device 700. The instantiation of the instance 706, as well as the virtualization layer 708 and software containers 704A-704R if implemented, are collectively referred to as software instance(s) 702.

Alternative implementations of an electronic device may have numerous variations from that described above. For example, customized hardware and/or accelerators might also be used in an electronic device.

FIG. 7B is a block diagram of a deployment environment according to some example implementations. A system 740 includes hardware (e.g., a set of one or more server devices) and software to provide service(s) 742, including a billing service. In some implementations the system 740 is in one or more datacenter(s). These datacenter(s) may be: 1) first party datacenter(s), which are datacenter(s) owned and/or operated by the same entity that provides and/or operates some or all of the software that provides the service(s) 742; and/or 2) third-party datacenter(s), which are datacenter(s) owned and/or operated by one or more different entities than the entity that provides the service(s) 742 (e.g., the different entities may host some or all of the software provided and/or operated by the entity that provides the service(s) 742). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 740 is coupled to user devices 780A-780S over a network 782. The service(s) 742 may be on-demand services that are made available to one or more of the users 784A-784S working for one or more entities other than the entity which owns and/or operates the on-demand services (those users sometimes referred to as outside users) so that those entities need not be concerned with building and/or maintaining a system, but instead may make use of the service(s) 742 when needed (e.g., when needed by the users 784A-784S). The service(s) 742 may communicate with each other and/or with one or more of the user devices 780A-780S via one or more APIs (e.g., a REST API). In some implementations, the user devices 780A-780S are operated by users 784A-784S, and each may be operated as a client device and/or a server device. In some implementations, one or more of the user devices 780A-780S are separate ones of the electronic device 700 or include one or more features of the electronic device 700.

In some implementations, the system 740 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 740 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 740 may include an application platform 744 that enables PAAS for creating, managing, and executing one or more applications developed by the provider of the application platform 744, users accessing the system 740 via one or more of user devices 780A-780S, or third-party application developers accessing the system 740 via one or more of user devices 780A-780S.

In some implementations, one or more of the service(s) 742 may use one or more multi-tenant databases 746, as well as system data storage 750 for system data 752 accessible to system 740. In certain implementations, the system 740 includes a set of one or more servers that are running on server electronic devices and that are configured to handle requests for any authorized user associated with any tenant (there is no server affinity for a user and/or tenant to a specific server). The user devices 780A-780S communicate with the server(s) of system 740 to request and update tenant-level data and system-level data hosted by system 740, and in response the system 740 (e.g., one or more servers in system 740) automatically may generate one or more Structured Query Language (SQL) statements (e.g., one or more SQL queries) that are designed to access the desired information from the multi-tenant database(s) 746 and/or system data storage 750.

In some implementations, the service(s) 742 are implemented using virtual applications dynamically created at run time responsive to queries from the user devices 780A-780S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 760 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 744 includes an application setup mechanism that supports application developers' creation and management of applications, which may be saved as metadata by save routines. Invocations to such applications, including the billing service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 782 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 740 and the user devices 780A-780S.

Each user device 780A-780S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 740. For example, the user interface device can be used to access data and applications hosted by system 740, and to perform searches on stored data, and otherwise allow one or more of users 784A-784S to interact with various GUI pages that may be presented to the one or more of users 784A-784S. User devices 780A-780S might communicate with system 740 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 780A-780S might include an HTTP client, commonly referred to as a “browser,” for sending and receiving HTTP messages to and from server(s) of system 740, thus allowing users 784A-784S of the user devices 780A-780S to access, process and view information, pages and applications available to it from system 740 over network 782.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

What is claimed is:

1. A method of generating an invoice at a database system, the method comprising:
identifying, using a key value associated with an invoice configuration, a plurality of records at the database system associated with the key value;
identifying, using the key value, invoice configuration metadata associated with the invoice configuration at the database system; and
providing an invoice graphical user interface (GUI) display at a client device coupled to the database system over a network, wherein the invoice GUI display comprises:
a first region including a first set of one or more invoice lines comprising respective field values for a first field of a first subset of the plurality of records grouped into a first group based on the invoice configuration metadata and a first common field value for a second field of the first subset of the plurality of records; and
a second region including a second set of one or more invoice lines comprising respective field values for the first field of a second subset of the plurality of records grouped into a second group based on the invoice configuration metadata and a second common field value for the second field of the second subset of the plurality of records.

2. The method of claim 1, further comprising automatically determining the key value based at least in part on an identifier associated with the invoice configuration and a third common value for a third field of the plurality of records.

3. The method of claim 2, wherein the first common field value for the first subset of the plurality of records is different from the second common field value for the second subset of the plurality of records.

4. The method of claim 2, wherein automatically determining the key value comprises combining the identifier associated with the invoice configuration and the third common value for the third field of a respective record of the plurality of records.

5. The method of claim 2, wherein the invoice configuration metadata comprises splitting criteria indicating invoices should be split based on the third field.

6. The method of claim 5, wherein the splitting criteria indicates invoices should not be split based on the first field or the second field.

7. The method of claim 5, wherein the invoice configuration metadata comprises hierarchical level assignment metadata indicating the third field is assigned to a first hierarchical level above a second hierarchical level assigned to the second field and the first field is assigned to a third hierarchical level below the second hierarchical level assigned to the second field.

8. The method of claim 1, wherein identifying the plurality of records comprises searching a database of the database system using the key value for a plurality of billing records including an invoice configuration field equal to the key value, wherein the plurality of records comprise the plurality of billing records.

9. The method of claim 1, wherein the invoice configuration metadata comprises splitting criteria indicating invoices should be split based on a third field of the plurality of records assigned to a hierarchical level above the second field of the plurality of records, wherein respective values for the third field are common across the plurality of records.

10. The method of claim 9, further comprising automatically determining the key value by concatenating an identifier associated with the invoice configuration and the respective values for the third field of the plurality of records when the splitting criteria indicates splitting based on the third field.

11. At least one non-transitory machine-readable storage medium that provides instructions that, when executed by at least one processor, are configurable to cause the at least one processor to perform operations comprising:
identifying, using a key value associated with an invoice configuration, a plurality of records at a database system associated with the key value;
identifying, using the key value, invoice configuration metadata associated with the invoice configuration at the database system; and
providing an invoice graphical user interface (GUI) display at a client device coupled to the database system over a network, wherein the invoice GUI display comprises:
a first region including a first set of one or more invoice lines comprising respective field values for a first field of a first subset of the plurality of records grouped into a first group based on the invoice configuration metadata and a first common field value for a second field of the first subset of the plurality of records; and
a second region including a second set of one or more invoice lines comprising respective field values for the first field of a second subset of the plurality of records grouped into a second group based on the invoice configuration metadata and a second common field value for the second field of the second subset of the plurality of records.

12. The at least one non-transitory machine-readable storage medium of claim 11, wherein the instructions are configurable to cause the at least one processor to automatically determine the key value based at least in part on an identifier associated with the invoice configuration and a third common value for a third field of the plurality of records.

13. The at least one non-transitory machine-readable storage medium of claim 12, wherein the first common field value for the first subset of the plurality of records is different from the second common field value for the second subset of the plurality of records.

14. The at least one non-transitory machine-readable storage medium of claim 12, wherein the instructions are configurable to cause the at least one processor to automatically determine the key value by combining the identifier associated with the invoice configuration and the third common value for the third field of a respective record of the plurality of records.

15. The at least one non-transitory machine-readable storage medium of claim 12, wherein the invoice configuration metadata comprises splitting criteria indicating invoices should be split based on the third field.

16. The at least one non-transitory machine-readable storage medium of claim 15, wherein the splitting criteria does not indicate splitting based on the first field or the second field.

17. The at least one non-transitory machine-readable storage medium of claim 16, wherein the instructions are configurable to cause the at least one processor to wherein the invoice configuration metadata comprises hierarchical level assignment metadata indicating the third field is assigned to a first hierarchical level above a second hierarchical level assigned to the second field and the first field is assigned to a third hierarchical level below the second hierarchical level assigned to the second field.

18. The at least one non-transitory machine-readable storage medium of claim 11, wherein the instructions are configurable to cause the at least one processor to search a database of the database system using the key value for a plurality of billing records including an invoice configuration field equal to the key value, wherein the plurality of records comprise the plurality of billing records.

19. The at least one non-transitory machine-readable storage medium of claim 11, wherein the invoice configuration metadata comprises splitting criteria indicating invoices should be split based on a third field of the plurality of records assigned to a hierarchical level above the second field of the plurality of records, wherein respective values for the third field are common across the plurality of records.

20. A computing device comprising:
at least one non-transitory machine-readable storage medium that stores software; and
at least one processor, coupled to the at least one non-transitory machine-readable storage medium, to execute the software that implements a billing service and that is configurable to:
identify, using a key value associated with an invoice configuration, a plurality of records at a database system associated with the key value;
identify, using the key value, invoice configuration metadata associated with the invoice configuration at the database system; and
provide an invoice graphical user interface (GUI) display at a client device coupled to the database system over a network, wherein the invoice GUI display comprises:
a first region including a first set of one or more invoice lines comprising respective field values for a first field of a first subset of the plurality of records grouped into a first group based on the invoice configuration metadata and a first common field value for a second field of the first subset of the plurality of records; and
a second region including a second set of one or more invoice lines comprising respective field values for the first field of a second subset of the plurality of records grouped into a second group based on the invoice configuration metadata and a second common field value for the second field of the second subset of the plurality of records.
